(19) United States
(12) Patent Application Publication
(10) Pub. No.: US 2014/0232023 A1
(43) Pub. Date: Aug. 21, 2014

(54) FALSE DOWNCOMER LIPS

(71) Applicant: FLUOR TECHNOLOGIES CORPORATION, Aliso Viejo, CA (US)

(72) Inventors: Henry Kister, Corona del Mar, CA (US); Carlos Trompiz, Deer Park, TX (US)

(73) Assignee: FLUOR TECHNOLOGIES CORPORATION, Aliso Viejo, CA (US)

(21) Appl. No.: 14/184,605

(22) Filed: Feb. 19, 2014

Related U.S. Application Data
(60) Provisional application No. 61/766,623, filed on Feb. 19, 2013.

(51) Int. Cl. B01D 3/42

(52) U.S. Cl. CPC B01D 3/4294
USPC 261/97; 202/262

(57) ABSTRACT

Embodiments of false downcomers are described having a lip extending inwardly from a bottom portion of the wall of the false downcomer. The lip has a length sufficient to deflect downward vapor from exiting through the bottom opening.

This application claims priority to U.S. provisional application having Ser. No. 61/766,626 filed on Feb. 19, 2013. This and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is distillation units.

### BACKGROUND

The following description includes information that may be useful in understanding the present invention. It is not an admission that any of the information provided herein is prior art or relevant to the presently claimed invention, or that any publication specifically or implicitly referenced is prior art.

Downcomers are typically used for each individual tray in conventional tray towers to conduct liquid from one tray to the tray below. The fluid entering each individual downcomer is the froth or spray from the tray above which is typically over 90-95% liquid by weight. A small amount of vapor contained in the froth or spray generally separates from the descending liquid in the downcomer. That vapor then ascends and vents out at the open end of the downcomer directly onto the tray above. Downcomers are primarily designed to prevent any sources of vapor other than that contained in the froth from entering the tray above the downcomer.

False downcomers are often used to introduce a feed or reflux into a distillation or absorption tower. The false downcomer functions to receive the feed fluid, separate the feed flash (vapor) from the feed liquid, vent the vapor to combine it with the tray vapor, and send the liquid down to combine with the liquid on the tray underneath. Typically, a feed enters via one or more pipe distributors having perforations or slots and that direct the incoming jets downwardly towards the walls of the false downcomer. The walls of the false downcomer can thereby catch the liquid and direct it downwards, while the vapor in the stream, if any, disengages and flows in an upward direction.

Unlike individual downcomers that receive fluid from an upper tray, “false” downcomers do not extend all the way to the tray above. Also, contrary to individual downcomers, the vapor venting is often obstructed in false downcomers by the feed pipe bringing the feed in. A major distinction is that while individual downcomers are designed to avoid vapor entry (other than in the incoming froth or spray), false downcomers are feed-flashing devices intended to handle vapor-containing feeds. Feeds into false downcomers often contain 30 to 60% vapor by weight. While individual downcomers are sometimes sloped, false downcomers are typically sloped at larger top-to-bottom area ratios due to the larger vapor content and the obstruction of the upper vapor escape area by feed pipes.

False downcomers are commonly used in large diameter towers, where they function to provide good distribution of the incoming liquid to multi-pass trays or packing distributors below. Both packings and multipass trays require good distribution of liquid to the section below to avoid issues associated with maldistribution. Maldistribution of the incoming liquid to the packing or to the passes of multi-pass trays can result in a large reduction in packing or tray efficiency, a large increase in energy usage, and a bottleneck of tower capacity.

Although the specific dimensions of the false downcomer will vary depending on the application, it is important to ensure that the false downcomer has a sufficient height, especially when sloped. If the false downcomer is too short, part of the vapor/liquid jet exiting from the distributor may miss the walls altogether, and flow straight into the opening below. In such circumstances, the vapor will hit the liquid surface below, and will likely cause turbulence on the liquid surface. Even if all the incoming feed hits the false downcomer walls, the short distance between the point of incidence and the bottom of the false downcomer may not be enough to deflect the vapor upwards, and some of the vapor will instead be diverted downwardly, causing turbulence at the liquid surface below.

The angle of incidence of the fluid jet leaving the holes or slots in the can be made shallower to alleviate this issue, but too shallow an angle can result in liquid being pushed up the walls of the false downcomer, resulting in splash and overflow. Any splash or overflow will be maldistributed, and cause poor separation efficiencies, larger energy consumption, and capacity loss. As a result, feed is typically issued from the pipe distributor at an angle of 45 degrees to the horizontal, and may be reduced to around 30 degrees to the horizontal when a shallower angle is needed due to a false downcomer height constraint. FIG. 1 illustrates a false downcomer of the prior art where feed is issued from the pipe distributor at an angle of 25 degrees.

Unfortunately, the height of the false downcomer is often constrained. In many towers, for example, especially during a retrofit, there is only a short tray spacing at the feed region, which highly constrains the height of the false downcomer. As a result, the angle at which the fluid jet issues from the pipe distributor should be reduced to avoid missing the lower ends of the short false downcomer and causing turbulence on the liquid surface. Often, the short length of the false downcomer also necessitates that the false downcomer walls are sloped at a relatively shallow angle, as shown in FIG. 1. When this occurs, the angle of incidence at the false downcomer wall (between the feed jet and the false downcomer wall) can be large, even greater than 90 degrees. At these large angles, especially those angles greater than 90 degrees, the vapor pushes liquid upwards, causing it to overflow the false downcomer walls. This liquid will be maldistributed, which may propagate down the tower, resulting in a loss of efficiency and capacity. In addition, the upward-moving liquid may be entrained by the vapor onto the next tray, creating a tower bottleneck.

In such situations, a common solution is to increase the tray spacing at the feed zone. This lengthens the false downcomer and helps deal with the conflicting constraints on the fluid jet angles. However, to accommodate a larger tray spacing in the feed zone of an existing tower, some trays and downcomers or packings must be removed, complicated piping and support changes, hot work on the tower shell and prolonging turnaround time. All of these modifications are costly, may lead to separation losses, higher energy consumption, even safety hazards. In some retrofits, hot work on the tower shell is not permitted. Often the costs and the difficulties of enlarging the tray spacing at the feed region are prohibitive and make a valuable debottleneck uneconomical.

It is known to include a lip at the bottom of an individual tray downcomer, e.g., U.S. Pat. No. 5,242,628 to Nye, U.S. Pat. No. 4,159,291 to Bruckert et al. and U.S. Pat. No. 7,370,846 to Xu et al. However, the size and layout of the lip is configured to prevent vapor from the tray below from entering the downcomer due to misalignment during installation, for example, rather than prevent vapor from a false downcomer from blowing out into the tray below.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for improved configurations of false downcomers that prevent vapor from a false downcomer from blowing out into the tray below.

### SUMMARY OF THE INVENTION

The inventive subject matter provides apparatus, systems and methods of false downcomers. Preferred false downcomers include an outer wall that at least partially defines a bottom opening and a lip or other projection extending from a bottom portion of the outer wall, and preferably extends inwardly from the bottom of the outer wall. The lip or projection preferably extends inwardly with respect to the outer wall, and preferably extends about an inner perimeter of the outer wall. Thus, for example, where the false downcomer has a circular horizontal cross-section, the lip could extend inwardly from the entire inner perimeter of the wall. Preferred lips or other projections have a length sufficient to deflect downward vapor from exiting through the bottom opening.

The lip or other projection advantageously helps prevent vapor impingement on the liquid surface below the false downcomer and can act to deflect any downward vapor component horizontally. Such embodiments of false downcomers are especially useful in retrofits and other situations where a height of the false downcomer is significantly limited. By using the lip, the height can be reduced while maintaining the efficiency of the false downcomer.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a schematic of a prior art false downcomer.

FIG. 2 is a schematic of one embodiment of a false downcomer of the inventive subject matter.

FIG. 3 is a schematic of another embodiment of a false downcomer of the inventive subject matter.

FIG. 4 is a schematic of an embodiment of an absorption tower having a false downcomer.

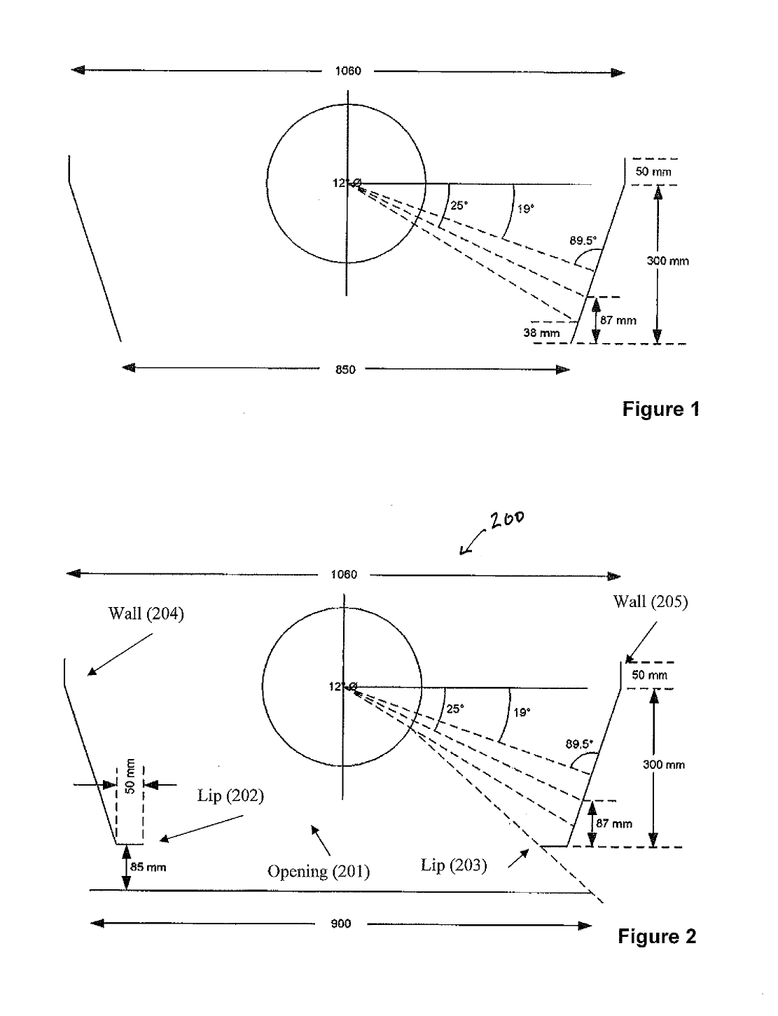

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

In FIG. 2, a vertical cross-section of a schematic of one embodiment of a false downcomer 200 is shown having walls 204, 205 that at least partially define a bottom opening 201 of the false downcomer, as well as an interior space within.

False downcomer includes short, horizontal lips 202, 203 or other projections at the bottom of each wall 204, 205 of the false downcomer 200, which at least partially defines a perimeter of the bottom opening 201. The lips 202, 203 preferably extend inwardly and toward one another. It is especially preferred that the lips 202, 203 comprise a single piece that extends inwardly from a perimeter of the wall 204 of the false downcomer 200. The lips 202, 203 preferably have a length sufficient to help prevent downward vapor from exiting through the bottom opening and deflect it upwardly. In this manner, the lips 202, 203 advantageously deflect any downward vapor horizontally, forcing it back into the false downcomer 200 instead of allowing it to hit the liquid surface below. As a result, the angle of issue of the fluid jet from the distributor pipe can be increased without the vapor missing the downcomer and hitting the liquid surface below. This allows for an absorption or other tower to be retrofitted without necessitating the tray spacing to be increased at the feed zone.

Although the precise dimensions can vary depending on the specific application, it is preferred that lips 202, 203 have a length of between 20-70 mm, and more preferably between 40-60 mm. As shown in FIG. 2, lips 202, 203 can each have a length of approximately 50 mm. However, it is also contemplated that the lips 202, 203 could each have a length of approximately 25 mm in some applications. The lips 202, 203 effectively reduce the diameter of the bottom opening 201 of the false downcomer 200.

It is also contemplated that the walls 204, 205 could compose a single piece and a unitary structure that defines an interior of the false downcomer 200. Thus, for example, a lip 202 can extend from wall 204, and preferably extends inwardly toward an interior of the false downcomer 200.

The walls 204, 205 can either be vertical or sloped walls, or a combination thereof. Sloped walls are often used when the feed is a flashing feed. Sloping the walls gives an opening large enough between the false downcomer wall and the inlet pipe to permit vapor ascent without much entrainment of liquid, while minimizing the area on the tray or distributor below that is consumed by the false downcomer or its footprint. As shown in FIG. 2, walls 204, 205 can each include a vertical upper portion and a sloped lower portion. In such embodiments, it is preferred that the lips 202, 203 extend in a direction that is normal to the vertical upper portion.

In some contemplated embodiments, an angle of intersection between the lip 202 and wall 204 is greater than 90 degrees.

In other contemplated embodiments, a length of the vertical upper portion of wall 204, for example, can be equal to a length of lip 202. It is further contemplated that the height of the wall and/or false downcomer 200 is no greater than 350 mm, although the specific dimensions will vary depending on the application.

The false downcomer 200 can be used in any distillation or absorption tower (e.g., new design or retrofit) when the feed is a flashing feed. The false downcomer 200 has many benefits when the tray spacing at the feed region is short and there is economics to prevent increasing this height. For example, in a retrofit, the false downcomer 200 will permit achieving an effective design which may not be possible without it if the spacing at the feed is short. In a new tower, the false downcomer 200 may permit a small reduction (about 300 mm) in tower height.

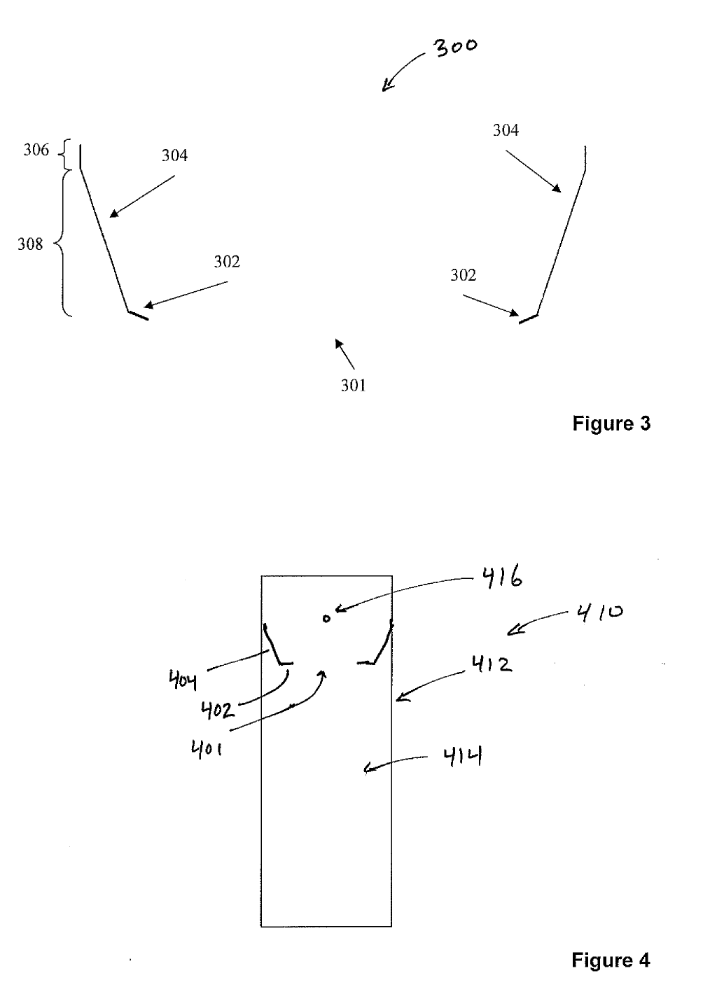

In FIG. 3, another embodiment of a false downcomer 300 is shown having a lip 302 extending from an outer wall 304 of the false downcomer 300. Rather than lie along a horizontal plane as in FIG. 2, lip 302 is downwardly sloped while still extending inwardly with respect to outer wall 304. With respect to the remaining numerals in FIG. 3, the same considerations for like components with like numerals of FIG. 2 apply.

FIG. 4 illustrates one embodiment of an absorption tower 410 having a false downcomer 400. The tower 410 preferably includes an outer housing 412 that defines an interior cavity 414. A fluid distributor 416 is at least partially disposed within the outer housing 412 and configured to feed a feed or reflux stream into the interior cavity 414. The false downcomer 400 can also be positioned within the interior cavity 414 such that the false downcomer 400 receives the feed or reflux stream, and distributes the feed or reflux stream to packing, etc. disposed below the false downcomer 400. Preferably, the false downcomer 400 includes a lip extending from its bottom portion that projects inwardly from an outer wall 404 of the false downcomer 400. With respect to the remaining numerals in FIG. 4, the same considerations for like components with like numerals of FIG. 2 apply.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A false downcomer, comprising:
a first wall that at least partially defines a bottom opening; and
a first lip extending from a bottom portion of the first wall that at least partially defines a perimeter of the bottom opening, wherein the first lip has a length sufficient to deflect downward vapor from exiting through the bottom opening.

2. The false downcomer of claim 1, wherein the first wall has a downward slope.

3. The false downcomer of claim 1, further comprising a second wall coupled to the first wall, and that at least partially defines the bottom opening.

4. The false downcomer of claim 1, wherein the first lip extends generally horizontally from the bottom portion of the first wall.

5. The false downcomer of claim 1, wherein the first lip extends normally from the first wall.

6. The false downcomer of claim 1, wherein an angle of intersection between the first lip and first wall is greater than 90 degrees.

7. The false downcomer of claim 1, wherein the length of the lip is between 40-60 mm.

8. The false downcomer of claim 1, wherein the first wall comprises a vertical portion and a sloped portion, and wherein a length of the vertical portion is equal to the length of the first lip.

9. The false downcomer of claim 1, wherein the first lip effectively reduces an area of the bottom opening.

10. The false downcomer of claim 1, wherein a height of the first wall is no greater than 350 mm.

11. A false downcomer, comprising:
an outer wall that at least partially defines an opening; and
a projection extending within the opening from a bottom of the outer wall, and wherein the projection at least partially defines a perimeter of the opening.

12. The false downcomer of claim 11, wherein the projection has a length sufficient to deflect downward vapor from exiting downward through the opening.

13. The false downcomer of claim 11, wherein the projection extends along a horizontal plane from the bottom of the outer wall.

14. The false downcomer of claim 11, wherein the projection extends normally from the outer wall.

15. The false downcomer of claim 11, wherein the length of the lip is between 40-60 mm.

16. The false downcomer of claim 11, wherein the outer wall comprises upper and lower portions, and wherein the upper portion is disposed vertically and the lower portion is sloped inwardly with respect to the upper portion, and wherein the projection extends inwardly with respect to the outer wall and in a direction that is normal to the upper portion.

17. The false downcomer of claim 16, wherein a length of the upper portion is equal to a length of the projection.

18. The false downcomer of claim 11, wherein a height of the first wall is no greater than 350 mm.

19. An absorption tower, comprising:
a housing that defines an interior cavity;
a fluid distributor configured to feed a feed or reflux stream into the interior cavity;
a false downcomer disposed within the housing and configured to distribute the feed or reflux stream to packing disposed below the false downcomer; and
wherein the false downcomer includes a lip that projects inwardly from an outer wall of the false downcomer.

20. The absorption tower of claim 19, wherein the lip has a length sufficient to deflect downward vapor from exiting downward through a bottom opening of the false downcomer.
